(19) United States
(12) Patent Application Publication
(10) Pub. No.: US 2010/0299100 A1
(43) Pub. Date: Nov. 25, 2010

(54) METHODS AND SYSTEMS INVOLVING DETERMINING SHAFT VELOCITY

(75) Inventors: Philip G. Bright, Auburn, MI (US); Steven James Collier-Hallman, Frankenmuth, MI (US)

Correspondence Address: Cantor Colburn LLP-General Motors, 20 Church Street, 22nd Floor, Hartford, CT, 06103, US

(73) Assignee: GM GLOBAL TECHNOLOGYOPERATIONS, INC., Detroit, MI (US)

(21) Appl. No.: 12/811,538

(22) PCT Filed: Dec. 31, 2008
(86) PCT No.: PCT/US08/88609

§ 371 Date: Aug. 9, 2010

Related U.S. Application Data
(60) Provisional application No. 61/018,955, filed on Jan. 4, 2008.

(51) Int. Cl. G06F 15/00; G01P 3/00

(52) U.S. Cl. 702/147

(57) ABSTRACT

A method of determining velocity of a shaft is provided. The method includes receiving a first shaft position signal and a second shaft position signal. Derivatives of each of the first shaft position signal and the second shaft position signal are computed, as are squares of each of the derivatives, a summation of the squares, and a square root of the summation. The velocity is output as a result of the square root.

### CROSS-REFERENCE TO RELATED APPLICATIONS

This application claims the benefit of International Application Serial No. PCT/US08/88609 filed Dec. 31, 2008, which claims the benefit of U.S. Provisional Application No. 61/018,955 filed Jan. 4, 2008. The disclosure of each of the above applications is incorporated herein by reference in its entirety.

### FIELD

The present invention relates to methods and systems for determining shaft velocity.

### BACKGROUND

Shaft position sensors such as, for example, those used in motor applications, output sine and cosine signals to provide position information to a controller. At a motor shaft position theta, the motor sensor puts out the following signals:

x=cos(theta)

y=sin(theta)

When implemented, some slight amplitude mismatch, harmonic content, phase offset, etc. may occur.

The controller determines a motor speed by deriving the speed from the position signals. One method (with many variations) is to determine the motor position at a time t1, then determine the motor position at time t2, and then calculate the velocity using the equation v=(pos1−pos2)/(t1−t2).

Depending on the system requirements and the method used to determine position, this approach may not provide adequate performance.

### SUMMARY OF THE INVENTION

Accordingly, a method of determining velocity of a shaft is provided. The method includes receiving a first shaft position signal and a second shaft position signal. Derivatives of each of the first shaft position signal and the second shaft position signal are computed, as are squares of each of the derivatives, a summation of the squares, and a square root of the summation. The velocity is output as a result of the square root The above features and advantages and other features and advantages of the present invention are readily apparent from the following detailed description of the embodiments for carrying out the invention when taken in connection with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention will become apparent from the following detailed description taken in conjunction with the drawings in which:

FIG. 1 illustrates a block diagram of a method for determining shaft velocity;

FIG. 2 illustrates an embodiment of a system for determining shaft velocity;

FIG. 3 illustrates a controller that implements the method of FIG. 1; and

FIG. 4 illustrates a velocity computation module of the controller of FIG. 2.

### DETAILED DESCRIPTION

The following description is merely exemplary in nature and is not intended to limit the present disclosure, application, or uses. It should be understood that throughout the drawings, corresponding reference numerals indicate like or corresponding parts and features.

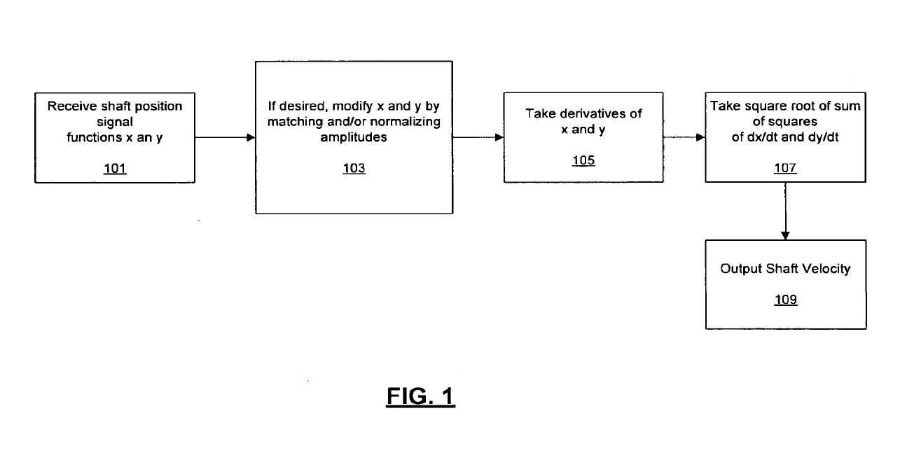

Referring now to FIG. 1, a block diagram illustrates a method of determining shaft velocity in accordance with an exemplary embodiment. As can be appreciated in light of the disclosure, the order of operation within the method is not limited to the sequential execution as illustrated in FIG. 1, but may be performed in one or more varying orders as applicable and in accordance with the present disclosure.

In one example, the shaft position signals (x and y) are received in block 101. Assuming the following signals from the motor position sensor:

x=cos(theta); and (1)

y=sin(theta). (2)

These are represented as:

x=cos(wt); and (3)

y=sin(wt). (4)

where w=shaft frequency in rad/s and t is time.

In block 103, any required processing such as amplitude matching or amplitude normalization is performed if desired (as will be discussed in more detail below). In block 105, derivatives are taken of the processed shaft position signals providing the following result:

$$\begin{matrix}\frac{d x}{d t} = w ( - sin ( wt ) ) ; and & ( 5 ) \\ \frac{d y}{d t} = w ( cos ( wt ) ) . & ( 6 )\end{matrix}$$

In block 107, the square root of the sum of the squares of dx/dt and dy/dt is taken. For example, each derivative is squared, and the squares are summed The velocity can then be determined by taking the square root of the result as follows:

$$\begin{matrix}\sqrt{[ {( \frac{d x}{d t} )}^{2} + {( \frac{d y}{d t} )}^{2} ]} = \sqrt{[ {{w}^{2} ( sin ( wt ) )}^{2} + {{w}^{2} ( cos ( wt ) )}^{2} ]} \\ = \sqrt{{w}^{2}} \\ = w .\end{matrix} \qquad ( 7 )$$

In block 109, the shaft velocity is output.

One benefit of this method is that velocity is determined without the need to calculate motor position. Another benefit is that any offset in the sine or cosine position signals will drop out due to the derivative operation. Furthermore, there are no trigonometric calculations.

In this method, the gain of the input signals (x and y) can be accounted for, particularly if the gain varies with different components. The equations above assume a gain of 1. If this is not the case, the gain will propagate thru the calculations and will scale the calculated velocity.

An exemplary embodiment of a method similar to the method described above where the input signals include offsets and the phases are assumed to match follows:

x=(A1(cos(wt)))+B1; and (8)

y=(A2(sin(wt)))+B2. (9)

where w=shaft frequency in rad/s, t is time, A is an amplitude, and B is an offset. Without including a correction of the input functions, the functions are processed as follows:

$$\begin{matrix}\frac{d x}{d t} = w \cdot A 1 ( - sin ( wt ) ) ; and & ( 10 ) \\ \frac{d y}{d t} = w \cdot A 2 ( cos ( wt ) ) . & ( 11 )\end{matrix}$$

The offsets, B1 and B2 have fallen out of the functions due to the derivative operation.

The square root of the sum of the squares of dx/dt and dy/dt yields the velocity signal:

$$velocity = w \cdot \sqrt{[ {( A 1 )}^{2} {( sin ( wt ) )}^{2} + {( A 2 )}^{2} {( cos ( wt ) )}^{2} ]} . \qquad ( 12 )$$

Assuming that A1 and A2 are approximately equal (A1≈A2), the result is

velocity=A·w. (13)

If the amplitude of the incoming signals is not 1, then the velocity signal will be scaled accordingly. The scaling may be accounted for if the amplitude is known. However, if this scaling is not desirable, normalizing the incoming sine and cosine signals to an amplitude of one may eliminate the scaling factor. The amplitude of matched cosine and sine signals can be determined using, for example, a CORDIC algorithm. The results of the CORDIC algorithm can be used to normalize the amplitude to one. The normalization of the incoming signals is particularly useful in an application in which the amplitude of the incoming signals may change over the service life of the system.

Assuming that A1 and A2 are not the same (A1≠A2), the result is a sinusoidal error signal that rides on the velocity signal. The frequency of the error signal is twice that of the incoming signals (x and y). A function that provides amplitude matching between the two signals will remove the error. Normalizing the amplitudes of the incoming signals to a value of one removes the amplitude mismatch, and also removes the amplitude-dependent scaling factor in the calculated velocity.

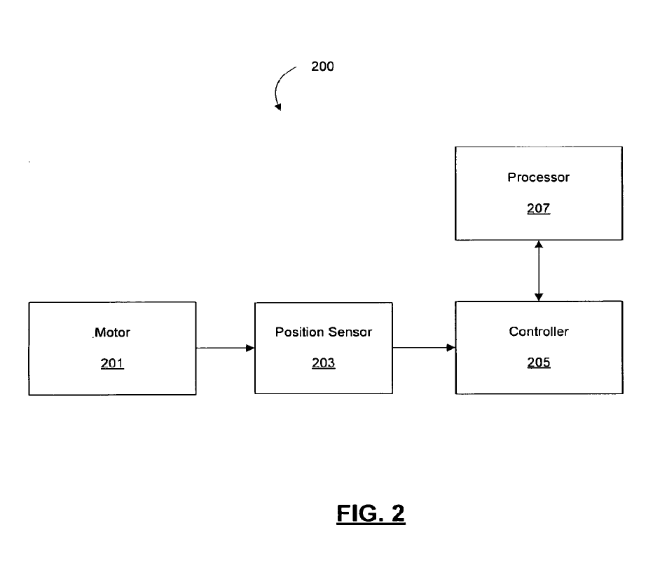

Referring now to FIG. 2, an exemplary embodiment of a system that may perform the method illustrated in FIG. 1 is shown. The system 200 includes a motor 201, a position sensor 203, communicatively linked to a controller 205, and a processor 207 communicatively linked to the controller 205. In operation, the position sensor 203 determines the position of the motor shaft (not shown) and sends a position signal to the controller 205. The controller 205 may perform a method similar to the method illustrated in FIG. 1. The controller 205 may control the motor 201, and may send and receive data to the processor 207. The processor 207 may be operative to control the motor 201 and may also control other system 200 functions.

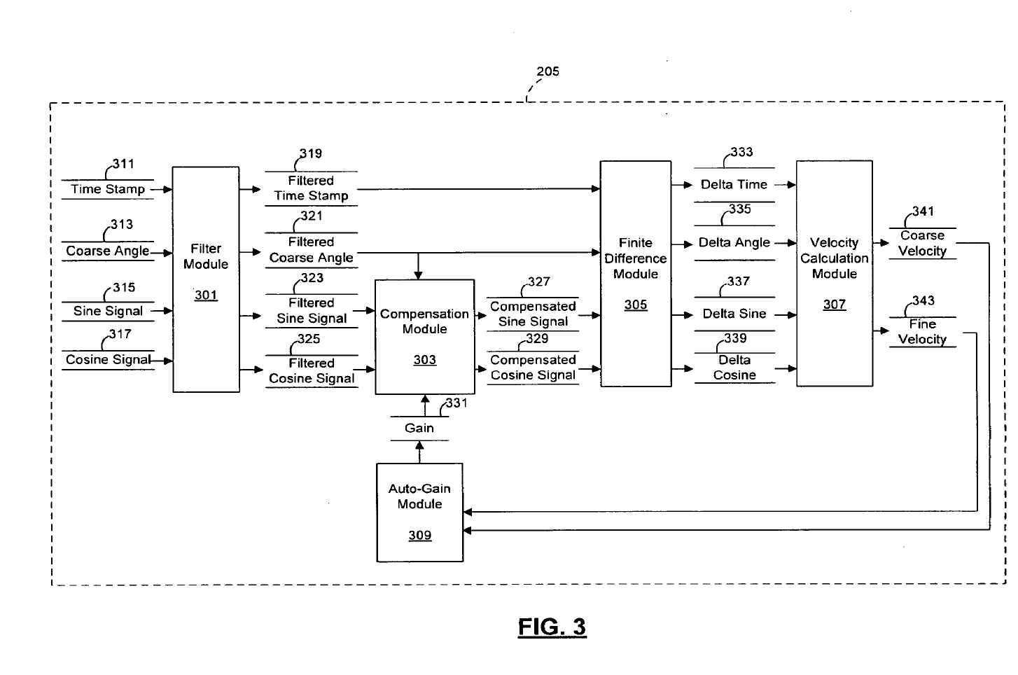

Referring now to FIG. 3, the controller 205 is shown in more detail in accordance with an exemplary embodiment. The controller 205 includes one or more sub-modules and datastores. As used herein, the term module or sub-module refers to an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules shown in FIG. 3 can be combined and/or further partitioned to similarly determine a shaft velocity. In this example, the controller 205 includes a filter module 301, a compensation module 303, a finite difference module 305, a velocity calculation module 307, and an auto-gain module 309.

The filter module 301 receives as input a time stamp 311, a coarse angle 313, a sine signal 315, and a cosine signal 317. The inputs can be generated by or determined from signals of the position sensor 203. The filter module 301 applies a filter to each of the inputs 311-317 to improve resolution in the signals and to reduce noise. In one example, the filter is at least one of a low pass filter, a recursive filter, or any other filter known in the art. As can be appreciated, the filters applied to the time stamp 311 and the coarse angle 313 take into account rollovers of the values. Based on the filtering, the filter module 310 outputs a filtered time stamp 319, a filtered coarse angle 321, a filtered sine signal 323, and a filtered cosine signal 325.

The compensation module 303 receives as input the filtered coarse angle 321, the filtered sine signal 323, the filtered cosine signal 325, and a gain 331. As will be discussed in more detail below, the gain 331 is selectively updated by the auto-gain module 309. The compensation module 303 determines a compensated sine signal 327 and a compensated cosine signal 329 by at least one of applying the gain 331 to the signals 323, 325 and/or applying a correction factor to the signals 323, 325.

In one example, the compensated signals 327, 329 are computed by multiplying the filtered sine signal 323 and the filtered cosine signal 325 by the gain 331. In another example, the compensated signals 327, 329 are computed by applying a correction factor for phase and harmonic compensation to the filtered sine signal 323 and the filtered cosine signal 325 based on the coarse angle 321. For example, the correction factors can be determined by two or more lookup tables that are accessed by some form of the coarse angle 321 and that output the correction factor. The correction factors are then subtracted from the filtered cosine signal 325 and the filtered sine signal 323 respectively (or from the gain compensated cosine signal and the gain compensated sine signal respectively).

The finite difference module 305 receives as input the compensated sine signal 327, the compensated cosine signal 329, the coarse angle 321, and the time stamp 319. The finite difference module 305 computes a finite difference for each of the inputs and generates a delta time 333, a delta angle 35, a delta sine 337, and a delta cosine 339. In one example, the finite difference module 305 computes the delta signals 333-339 by subtracting a previous signal from the present signal.

The velocity calculation module 307 receives as input the delta time 333, the delta angle 335, the delta sine 337, and the delta cosine 339. Based on the inputs 333-339, the velocity calculation module 307 computes a velocity magnitude and a velocity direction and generates a fine velocity 343. In various embodiments, the velocity calculation module 307 computes a coarse velocity 341 to be used by the auto-gain module 309.

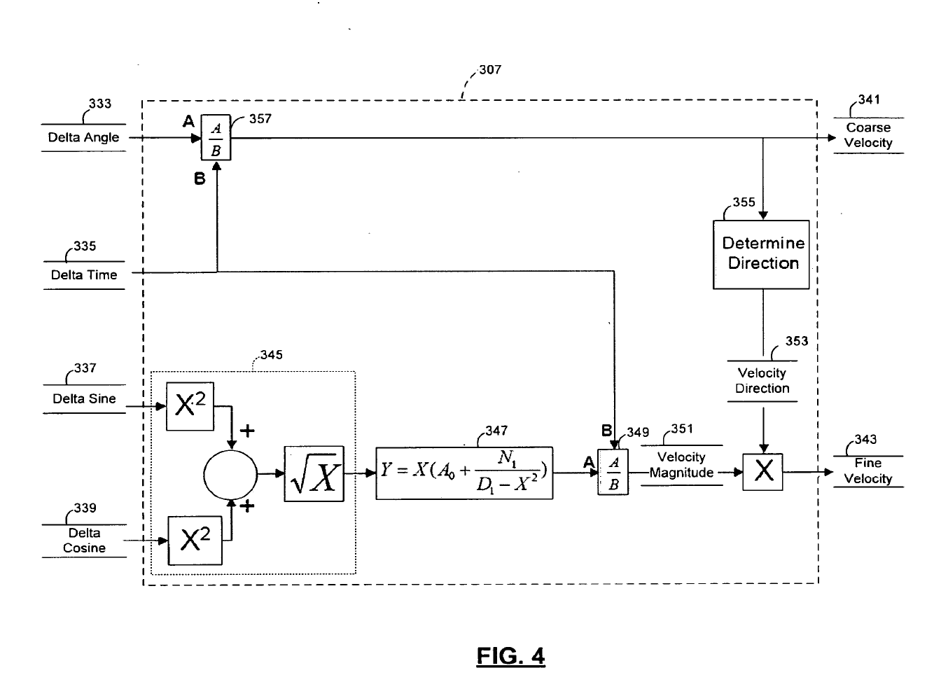

More particularly, as shown in FIG. 4, the computation module 307 computes the fine velocity 343 by computing a square root of the summation of the squares of the delta sine 337 and the delta cosine 339 at 345. Thereafter, a correction for the derivative magnitude error is applied to the result at 347. In one example, the correction factor is determined according to a polynomial approximation for arcsine as known in the art. The result of the correction is then divided by the delta time 335 at 349 to establish the velocity magnitude 351.

The velocity computation module 307 then computes a velocity direction 353 by determining the delta angle 333 over delta time at 357 and, for example, comparing the result to a previous delta angle over delta time at 355. The velocity direction 353 is applied to the velocity magnitude 351 to determine the fine velocity 343. Additionally, the velocity computation module 307 outputs the coarse velocity 341 based on, for example, the delta angle 333 over the delta time 335.

With reference back to FIG. 3, the auto-gain computation module 309 receives as input the fine velocity 343 and the coarse velocity 341. The auto-gain module 309 selectively integrates the gain 331 value based on a comparison of the coarse velocity 341 and the fine velocity 343. In various embodiments, the auto-gain module 309 integrates the gain 331 only if predetermined conditions are met. For example, the auto-gain module 309 applies an integrator gain to the difference between the coarse velocity 341 and the fine velocity 343 when the coarse velocity 341 is within a predetermined range.

While the invention has been described with reference to exemplary embodiments, it will be understood by those of ordinary skill in the pertinent art that various changes may be made and equivalents may be substituted for the elements thereof without departing from the scope of the present disclosure. In addition, numerous modifications may be made to adapt the teachings of the disclosure to a particular object or situation without departing from the essential scope thereof. Therefore, it is intended that the claims not be limited to the particular embodiments disclosed.

1. A method of determining velocity of a shaft, the method comprising:
receiving a first shaft position signal and a second shaft position signal;
computing derivatives of each of the first shaft position signal and the second shaft position signal;
computing squares of each of the derivatives;
computing a summation of the squares;
computing a square root of the summation; and
outputting a result of the square root as the velocity.

2. The method of claim 1, further comprising applying a filter to the first shaft position signal and the second shaft position signal.

3. The method of claim 1, further comprising applying at least one of a correction factor and a gain to the first shaft position signal and the second shaft position signal.

4. The method of claim 1, further comprising determining a first delta between the first shaft position signal and a previous first shaft position signal and determines a second delta between the second shaft position signal and a previous second shaft position signal.

5. The method of claim 4, wherein the computing the derivatives of each of the first shaft position signal and the second shaft position signal further comprises computing the derivatives of each of the first delta and the second delta.

6. A system for determining velocity of a shaft, the system comprising:
a controller that communicates with a shaft position sensor, wherein the controller determines the shaft velocity by:
receiving a first shaft position signal and a second shaft position signal from the shaft position sensor;
computing derivatives of each of the first shaft position signal and the second shaft position signal;
computing squares of each of the derivatives;
computing a summation of the squares;
computing a square root of the summation; and
outputting a result of the square root as the velocity.

7. The system of claim 6 wherein the controller determines the shaft velocity further by applying a filter to the first shaft position signal and the second shaft position signal.

8. The system of claim 6 wherein the controller determines the shaft velocity further by applying at least one of a correction factor and a gain to the first shaft position signal and the second shaft position signal.

9. The system of claim 6 wherein the controller determines the shaft velocity further by determining a first delta between the first shaft position signal and a previous first shaft position signal and a second delta between the second shaft position signal and a previous second shaft position signal.

10. The system of claim 6 further comprising the shaft position sensor that senses a position of a shaft and that generates the first shaft position signal and the second shaft position signal based thereon.

11. A system for determining velocity of a shaft, the system comprising:
a signal input that receives a first shaft position signal and a second shaft position signal; and
a velocity calculation module that determines the velocity of the shaft by computing a square root of a summation of squares of a derivative of the first shaft position signal and a derivative of the second shaft position signal.

12. The system of claim 11 further comprising:
a difference module that determines a first delta of the first shaft position signal and a previous first shaft position signal, and that determines a second delta between the second shaft position signal and a previous second shaft position signal, and
wherein the velocity calculation module further determines the velocity of the shaft by computing the square root of the summation of squares of a derivative of the first delta and a derivative of the second delta.

13. The system of claim 11 further comprising:
a compensation module that applies at least one of a correction factor of at least one of amplitude and harmonic frequency, and a gain to the first position signal and the second position signal to produce a first compensated signal and a second compensated signal, and
wherein the velocity calculation module further determines the velocity of the shaft by computing the square root of the summation of squares of a derivative of the first compensated signal and a derivative of the second compensated signal.

14. The system of claim 13 further comprising an auto-gain module that selectively computes the gain based on the velocity of the shaft and a coarse velocity of the shaft.

15. The system of claim 13 wherein the auto-gain module computes the gain based on predetermined enable conditions.

16. The system of claim 11 further comprising:
a filter module that filters the first shaft position signal and the second shaft position signal to produce a first filtered signal and a second filtered signal, and
wherein the velocity calculation module further determines the velocity of the shaft by computing the square root of the summation of squares of a derivative of the first filtered signal and a derivative of the second filtered signal.

17. The system of claim 11 wherein the velocity calculation module further determines the velocity of the shaft by applying a correction of a derivative magnitude error to a result of the square root of the summation of squares of the derivative of the first position signal and the derivative of the second position signal.

18. The system of claim 17 wherein the correction factor is a polynomial approximation for arcsine.

19. The system of claim 11 further comprising:
a second signal input that receives a time stamp associated with the first shaft position signal and a second shaft position signal, and
wherein the velocity calculation module further determines a magnitude of the velocity by dividing the result of the square root of the summation of the squares of the derivative of the first position signal and the derivative of the second position signal by the timestamp.

20. The system of claim 19 further comprising:
a third signal input that receives a coarse angle associated with the first shaft position signal and a second shaft position signal, and
wherein the velocity calculation module determines a direction of the velocity based on the coarse angle and the time stamp.
